(19) United States
(12) Patent Application Publication
(10) Pub. No.: US 2025/0050473 A1
(43) Pub. Date: Feb. 13, 2025

(54) APPARATUS FOR TIGHTENING THREADED FASTENERS

(71) Applicant: HYTORC Division UNEX Corporation, Mahwah, NJ (US)

(72) Inventors: John K. JUNKERS, Saddle River, NJ (US); Peter KOPPENHOEFER, Portland, PA (US)

(73) Assignee: HYTORC Division UNEX Corporation, Mahwah, NJ (US)

(21) Appl. No.: 18/642,949

(22) Filed: Jul. 8, 2024

Related U.S. Application Data
(62) Division of application No. 14/786,949, filed on Oct. 23, 2015, now abandoned.

(51) Int. Cl. B25B 13/48; B25B 7/10; B25B 17/00; B25B 17/02; B25B 23/00

(52) U.S. Cl. CPC B25B 13/481; B25B 7/10; B25B 17/00; B25B 17/02; B25B 23/0078

(57) ABSTRACT

An offset drive link assembly for transmission and multiplication of torque from a power tool for tightening or loosening a threaded fastener includes: a drive force input assembly having a drive force input engagement to receive a first turning force from the device acting in a first direction; a drive force output assembly, operatively engageable with the drive force input engagement, having a drive force output engagement to transfer the first turning force to the fastener; a reaction force assembly having a reaction force input engagement to receive a second turning force from the device in a second direction and a reaction force output engagement including: a recess to transfer the second turning force to a stationary object formed as a washer under the threaded fastener nonrotatably engageable with the recess; and a removably and rotatably engagable reaction force transfer fixture formed as a reaction arm.

### CROSS REFERENCE TO RELATED APPLICATIONS

This application is either a U.S. National application Filed Under 35 U.S.C. 371, divisional patent application, continuation patent application or a continuation-in-part patent application of the following commonly owned and/or co-pending patent applications, entire copies of which are incorporated herein by reference: U.S. Application Ser. No. 61/815,428, having Filing Date of 24 Apr. 2013, entitled “APPARATUS FOR TIGHTENING THREADED FASTENERS”; U.S. Application Ser. No. 61/903,254, having Filing Date of 12 Nov. 2013, entitled “APPARATUS FOR TIGHTENING THREADED FASTENERS”; U.S. Application Ser. No. 61/916,926, having Filing Date of 17 Dec. 2013, entitled “APPARATUS FOR TIGHTENING THREADED FASTENERS”; U.S. Application Ser. No. 61/940,919, having Filing Date of 18 Feb. 2014, entitled “APPARATUS FOR TIGHTENING THREADED FASTENERS”; PCT Application Serial No. PCT/US2014/035375, having Filing Date of 24 Apr. 2014, entitled “APPARATUS FOR TIGHTENING THREADED FASTENERS”; and U.S. application Ser. No. 14/786,949, having Filing Date of 23 Oct. 2015, entitled “APPARATUS FOR TIGHTENING THREADED FASTENERS”.

Innovations disclosed in this application advance technology disclosed in the following commonly owned issued patents and patent applications, entire copies of which are incorporated herein by reference, including: U.S. Pat. No. 5,140,874, having Issue Date of 25 Aug. 1992, entitled “FLUID-OPERATED WRENCH”; U.S. Pat. No. 7,451,672, having Issue Date of 18 Nov. 2008, entitled “LINK ATTACHMENT TO TORQUE WRENCH”; and U.S. patent application Ser. No. 14/241,354, having Filing Date of 26 Feb. 2014, entitled “APPARATUS FOR TIGHTENING THREADED FASTENERS”.

### BACKGROUND

Threaded fasteners including bolts, studs, nuts and washers are known and used in traditional bolting applications. Maintenance and repair of industrial applications begin with loosening of and end with tightening of these threaded fasteners. Often these fasteners are utterly inaccessible or unreachable with tools readily available to an operator due to, for example, protruding threads, limited clearances and bolting application obstructions. Naturally industry seeks to reduce production loss during routine, unforeseen and/or emergency maintenance and/or repair.

The present application relates to offset link attachments for torque power tools for such inaccessible and/or unreachable fasteners. Known link attachments include pawl-ratchet mechanisms or oscillating levers for tightening and loosening of such fasteners. It is believed that known link attachments can be further improved.

More generally, examples of Applicant's patent evolution is disclosed for the following product lines and drivers and tools for use therewith in the following commonly owned issued patents and patent applications, entire copies of which are incorporated herein by reference, including: traditional reaction fixtures in U.S. Pat. Nos. 4,671,142, 4,706,526, 5,016,502, RE33,951, 6,152,243, D500060 and 7,765,895; the HYTORC NUT™ in U.S. Pat. Nos. 5,318,397, 5,341,560, 5,499,9558, 5,538,379, 5,539,970, 5,640,749, 5,946,789, 6,152,243, 6,230,589, 6,254,323 and 6,461,093; the HYTORC WASHER™ in U.S. Pat. Nos. 6,490,952, 6,609,868, 6,883,401, 6,929,439, 6,986,298, 7,003,862, 7,066,053, 7,125,213, 7,188,552, 7,207,760 and 7,735,397; the HYTORC® XXI® in U.S. Pat. No. 6,298,752; the HYTORC jGUN®, FLIP-Gun®, THRILL® Gun and Z™ Gun in U.S. Pat. Nos. 6,490,952, 6,609,868, 6,883,401, 6,929,439, 6,986,298, 7,003,862, 7,066,053, 7,125,213, 7,188,552; 7,207,760, 7,641,579, 7,735,397, 7,798,038, 7,832,310, 7,950,309, 8,042,434, D608,614, and U.S. application Ser. No. 13/577,995 and 61/916,926.

### DESCRIPTION OF THE PREFERRED EMBODIMENTS

An offset drive link assembly for transmission and multiplication of torque from a power tool for tightening or loosening a threaded fastener includes: a drive force input assembly having a drive force input engagement to receive a first turning force from the device acting in a first direction; a drive force output assembly operatively engageable with the drive force input engagement, having a drive force output engagement to transfer the first turning force to the fastener; and a reaction force assembly having a reaction force input engagement to receive a second turning force from the device in a second direction and a reaction force output engagement to transfer the second turning force to a stationary object.

Advantageously the offset drive link assembly: allows access to previously unreachable fasteners due to, for example protruding threads, limited clearances and obstructions; makes practical previously unusable devices driven either electrically, hydraulically, manually and/or pneumatically; makes feasible previously unusable advanced materials, such as, for example aircraft-grade aluminum; creates modular components, such as, for example hex-reducing and -increasing drive bushings, male to female drive adaptors, to meet bolting application characteristics; yields accurate and customized torque multiplication; tames drive force and reaction force application; overcomes corrosion, thread and facial deformation; avoids bolt thread galling; nullifies side load; ensures balanced bolt load for symmetrical joint compression; simplifies link and tool use; minimizes risk of operator error; and maximizes bolting safety.

The invention may be described by way of example only with reference to the accompanying drawings, of which:

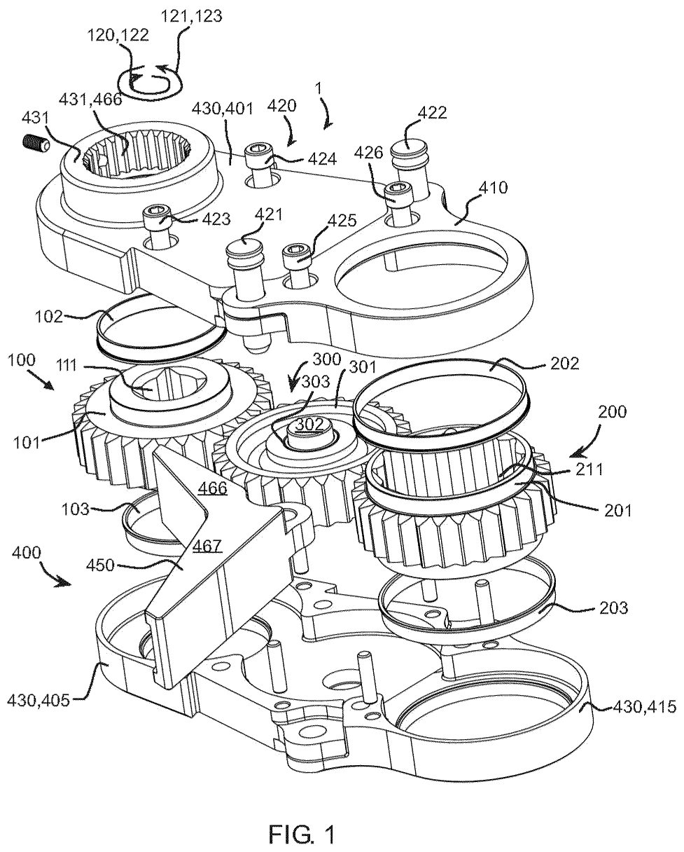

FIG. 1 is an exploded perspective view of an embodiment of the present invention in the form of an apparatus 1;

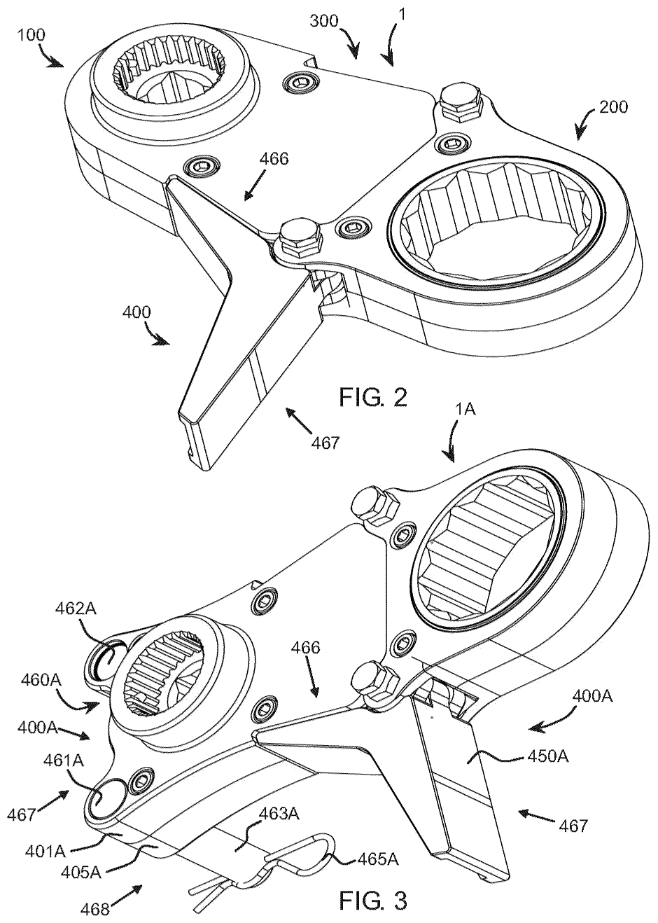

FIG. 2 is a perspective view of an embodiment of the present invention in the form of apparatus 1;

FIG. 3 is a perspective view of an embodiment of the present invention in the form of an apparatus 1A;

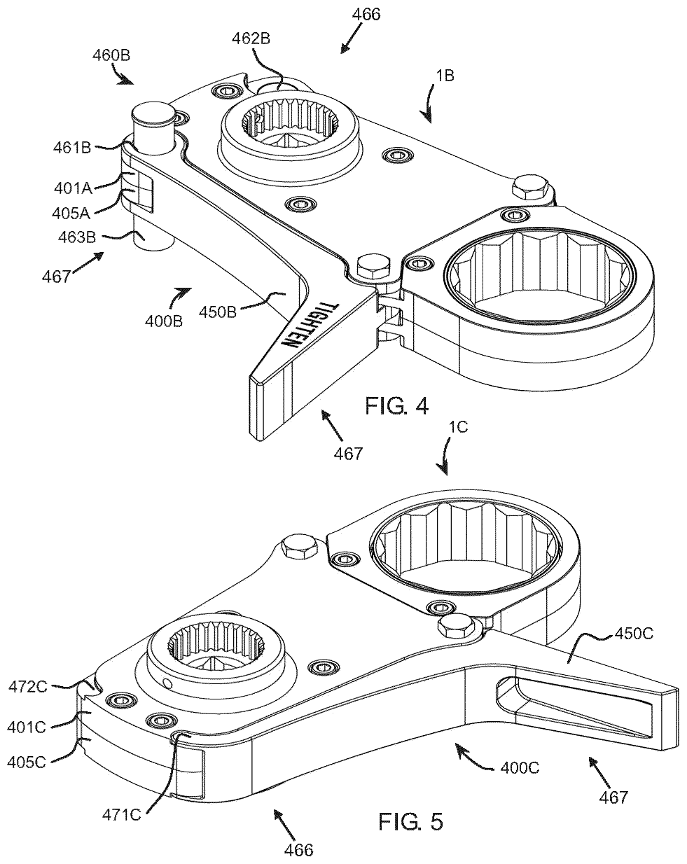

FIG. 4 is a perspective view of an embodiment of the present invention in the form of an apparatus 1B;

FIG. 5 is a perspective view of an embodiment of the present invention in the form of an apparatus 1C;

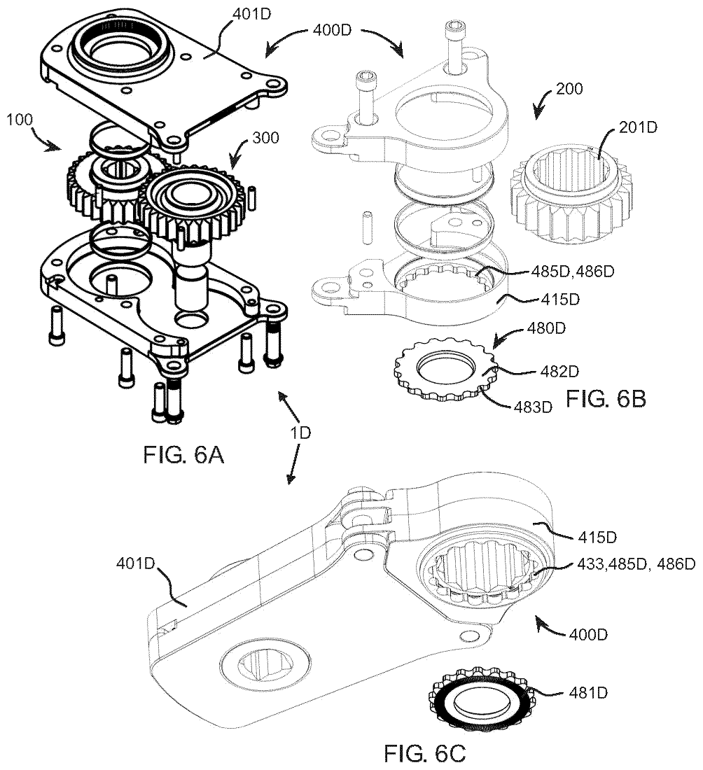

FIG. 6A is an exploded and separated perspective view of portions of an embodiment of the present invention in the form of an apparatus 1D;

FIG. 6B is an exploded and separated perspective view of portions of an embodiment of the present invention in the form of an apparatus 1D;

FIG. 6C is a perspective view of an embodiment of the present invention in the form of apparatus 1D;

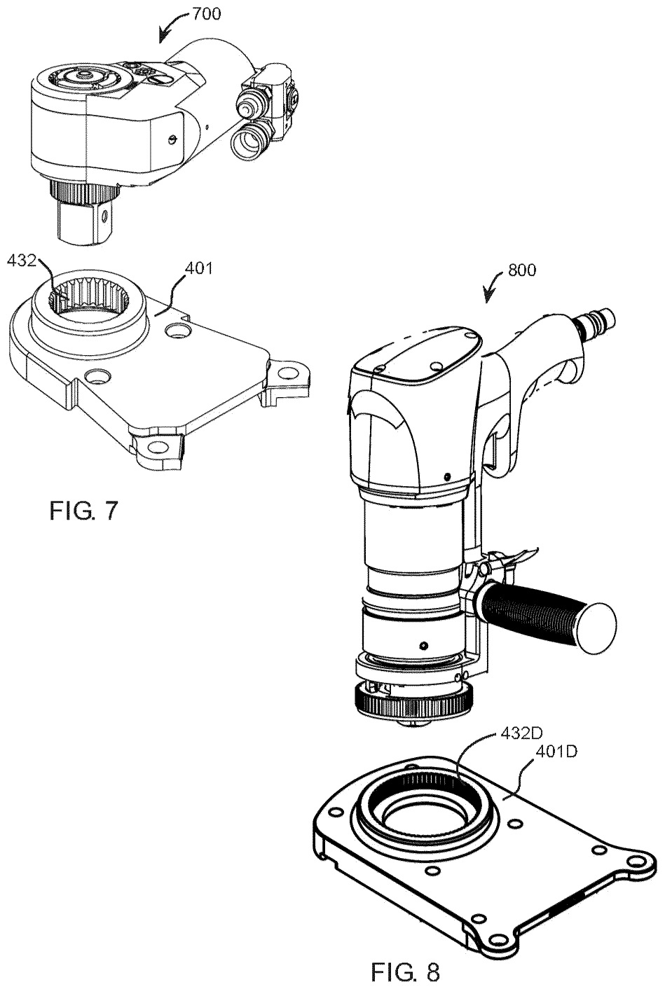

FIG. 7 is a perspective view of portions of an embodiment of the present invention in the form of apparatus 1 with an hydraulic torque tool;

FIG. 8 is a perspective view of portions of an embodiment of the present invention in the form of apparatus 1D with a pneumatic torque tool;

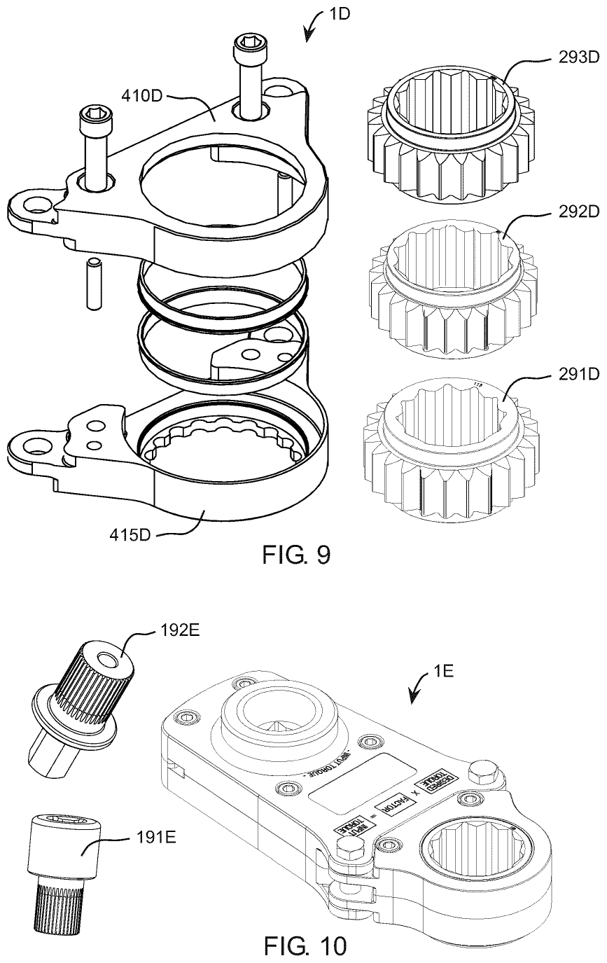

FIG. 9 is an exploded perspective view of portions of an embodiment of the present invention in the form of apparatus 1D with three modular drive force output gears of various sizes; and

FIG. 10 is a perspective view of an embodiment of the present invention in the form of an apparatus 1E with two modular drive force input engagements.

Referring to FIG. 1, by way of example, it shows an exploded perspective view of an embodiment of the present invention in the form of apparatus 1, or offset drive link assembly 1, for transmission and multiplication of torque from a device (not shown) for tightening or loosening a threaded fastener (not shown). Apparatus 1 includes: a drive force input assembly 100; a drive force output assembly 200; and a reaction force assembly 400. Apparatus 1 further includes a drive force idler assembly 300, but note that it's not required. Referring to FIG. 2, by way of example, it shows a perspective view of apparatus 1.

Drive force input assembly 100 includes a drive force input gear 101, or drive force input engagement 101, formed between a first and a second reaction force assembly housing 401 and 405. A first drive force input gear sleeve 102 is formed between first reaction force assembly housing 401 and drive force input gear 101. A second drive force input gear sleeve 103 is formed between second reaction force assembly housing 405 and drive force input gear 101.

Drive force output assembly 200 includes a drive force output gear 201, or drive force output engagement 201, formed between third and fourth reaction force assembly housing 410 and 415. A first drive force output gear sleeve 202 is formed between third reaction force assembly housing 410 and drive force output gear 201. A second drive force output gear sleeve 203 is formed between fourth reaction force assembly housing 415 and drive force output gear 201.

Tool drive idler assembly 300 includes a drive force idler gear 301 formed about a tool drive idler pin 302. A tool drive idler bushing 303 is formed between idler gear 301 and idler pin 302. Tool drive idler assembly 300 is formed within offset drive link assembly 1 and between drive force input gear 101 and drive force output gear 201.

Reaction force assembly 400 includes: first and second reaction force assembly housing 401 and 405, formed as a top and a bottom, respectively, near drive force input assembly 100; and third and fourth reaction force assembly housing 410 and 415, formed as a top and a bottom, respectively, near drive force output assembly 200. A reaction arm 450 is: integral with offset drive link assembly 1; formed adjacent assembled reaction force assembly housings 401, 405, 410 and 415; and held in place by a first reaction force assembly link pin 421. Reaction arm 450 may be formed on the other side of offset drive link assembly 1 and held in place by a second reaction force assembly link pin 422.

Fastenings 420 draw together components of offset drive link assembly 1 and include: first and second reaction force assembly link pins 421 and 422; a first, a second, a third and a fourth reaction assembly socket head cap screw 423, 424, 425 and 426; and various dowel pins. Once secured, fastenings 420 assemble drive force input assembly 100, drive force output assembly 200, drive force idler assembly 300, and reaction force assembly 400.

Drive force input gear 101 includes a drive force input square drive 111, or drive force input polygonal adaptor 111, to receive a first turning force 120, or a drive force 120, acting in a first direction 122. First reaction force assembly housing 401 includes a reaction force input spline 431, or reaction force input polygonal adaptor 431, to receive a second turning force 121, or a reaction force 121, acting in a second direction 123. Drive force 120 and reaction force 121 are substantially equal to and in opposite direction of each other.

Drive force input gear 101 transfers drive force 120 to drive force idler gear 301, which transfers drive force 120 to drive force output gear 201. First reaction force assembly housing 401 substantially transfers reaction force 121 to reaction arm 450, which then substantially transfers reaction force 121 to a stationary object.

Drive force output gear 201 may be formed in any suitable size or geometry, such as hexagonal or 12 point. Drive force output gear 201 may be formed in any size and/or any shape to accommodate any size and/or any shape threaded fastener for use with inaccessible or unreachable bolting applications.

FIG. 3 is a perspective view of another embodiment of the present invention in the form of apparatus 1A having a reaction force assembly 400A. Reaction force assembly 400A includes: a reaction arm 450A; and a reaction pin assembly 460A. Reaction pin assembly 460A includes: a first and a second reaction hole 461A and 462A; a reaction pin 463A; and a cotter pin 465A. Reaction force assembly 400A may be used with or without reaction arm 450A to transfer the reaction force to a stationary object. Note the change in shape of reaction force assembly housings 401A and 405A.

FIG. 4 is a perspective view of another embodiment of the present invention in the form of apparatus 1B having a reaction force assembly 400B. Reaction force assembly 400B includes: a reaction arm 450B; and a reaction pin assembly 460B. Reaction pin assembly 460B includes: a first and a second reaction hole 461B and 462B; and a reaction pin 463B. Reaction force assembly 400B may be used with or without reaction arm 450B to transfer the reaction force to a stationary object. Note the modifications in reaction arm 450B, which extends the length of and is held in place against, by reaction pin 463B, modified reaction force assembly housings 401B and 405B.

FIG. 5 is a perspective view of another embodiment of the present invention in the form of apparatus 1C having a reaction force assembly 400C. Reaction assembly 400C includes a reaction arm 450C. Reaction arm 450C extends the length of modified reaction force assembly housings 401C and 405C. Reaction inlets 471C and 472C hold reaction arm 450C in place. Note the slight modification to reaction arm 450C.

Referring to FIGS. 6A and 6B, by way of example, these show an exploded and separated perspective view of an embodiment of the present invention in the form of an apparatus 1D. FIG. 6C is a perspective view of an embodiment of the present invention in the form of apparatus 1D. Similar to apparatus 1A, 1B and 1C, apparatus 1D varies only in its reaction force assembly 400D. Reaction force assembly 400D utilizes Applicant's Z™ washer, gun, driver and offset link technologies disclosed in the following commonly owned and co-pending patent applications, entire copies of which are incorporated herein by reference: U.S. Application Ser. No. 61/916,926, having Filing Date of 17 Dec. 2013, entitled “APPARATUS FOR TIGHTENING THREADED FASTENERS”; and U.S. Application Ser. No. 61/940,919, having Filing Date of 18 Feb. 2014, entitled “APPARATUS FOR TIGHTENING THREADED FASTENERS”.

International bolting standards call for a hardened washer to be placed under every threaded fastener. Z™ Washers are hardened washers proprietary to the Applicant, HYTORC®, that become the reaction point for torqueing tools right under the nut or bolt head. They eliminate any possible pinch points for operators' appendages. Operators need not searching for satisfactory stationary objects. Straight, co-axial tensioning all but eliminates bending and/or side-loading of the stud. They provide a smooth, consistent, low-friction surface on which turns the nut or bolt head. The top has a polished surface against which the nut or bolt head will turn, while the bottom, which goes next to the flange face, is knurled to prevent rotation as the nut is tightened. Z™ Washers protect flange surfaces from damage or embedment and evenly distribute bolt load around the joint due to larger surface area. They can be made in a full range of inch and metric sizes from a full range of materials options for every application. They comply with all ASME, ASTM and API requirements for dimensions, hardness, and thickness. They work with pneumatic, hydraulic, electric and manual torque tools. And with the addition of a companion friction washer, it eliminates the need for a backup wrench to prevent the opposite nut from turning along with the bolt.

Z™ Washer benefits are achievable with dual action and reaction sockets proprietary to HYTORC®, which hold on to the washer and turn the nut against it.

The second method, as claimed herein and shown fully in FIGS. 6A, 6B and 6C and partially in FIGS. 7 and 8, utilizes HYTORC®'s proprietary dual drive offset link, such as, for example, apparatus 1D. Link 1D is powered by HYTORC®'s proprietary coaxial action and reaction torque tools, such as, for example, the HYTORC® ICE® 700 hydraulic torque tool or the HYTORC® Z™ Gun 800 pneumatic torque multiplier. Other such tools include HYTORC®'s proprietary jGUN® Single Speed, jGUN® Dual Speed Plus, AVANTI® and/or STEALTH®.

Generally during a tightening operation, a bottom knurled face 481D of Z™ Washer 480D rests on a joint to be closed while a bottom face of a nut or bolt head to be tightened rests on a top smooth face 482D of Z™ Washer 480D. Polygonal edges 483D of Z™ Washer 480D nonrotatably engage with and react in a recess 485D of an outer socket 415D of reaction force assembly 400D. Meanwhile an outer socket 201D of drive force output assembly 200 tightens the nut or bolt head over Z™ Washer 480D.

Referring to FIG. 9, by way of example, this shows is an exploded perspective view of portions of an embodiment of the present invention in the form of apparatus 1D with three modular drive force output gears 291D, 292D and 293D of various sizes. Referring to FIG. 10, by way of example, this shows a perspective view of an embodiment of the present invention in the form of an apparatus 1E with two modular drive force input engagements 191E and 192E. To combine a HYTORC® proprietary coaxial action and reaction torque tool with a HYTORC® proprietary offset link begin by choosing the correct size and geometry of ratcheting socket for the nut to be tightened and for the correct size and geometry of the square drive in tool. The links are easily exchanged by removing the two retaining bolts.

The direction, whether to tighten or loosen is determined by the direction of the tightening wrench. The word “tighten” or “loosen” is stamped into the side of the tool and can be read once the drive of the tool has been inserted into the drive receptacle.

Each offset link is marked with a “factor” which indicates how to compensate for any gear-ratio effects through the link. Each unique socket insert is marked with its “factor”. The desired torque to be applied to the nut is multiplied by this factor to determine the input torque value on the appropriate torque to pressure conversion chart for the tool being used. Note that other methods exist.

Offset drive link assemblies of the present application are flexibly adjustable to any bolting application environment due to interchangeable tool drive input assemblies, tool drive output assemblies and tool drive reaction assemblies. Such interchangeability allows for adjustment to varied fastener sizes and/or shapes. Operators no longer need several offset links of varying size for varied worksite applications, nor do operators need to completely disassemble and reassemble the links. The reaction force is passed on the housing of the offset link, which will abut against a stationary object. To ensure that the reaction force does not destroy the housing and to ensure a solid abutment, the link contains a reaction member or a Z™ Washer engagement, which can be switched from one side to another of the link housing for tightening and loosening. Rather than having to turn the link over, as is the case with links on other limited clearance hydraulic tools, links of the present application remain in position. The reaction arm is merely changed from one side to the other. If hydraulic the tool is flipped over; if pneumatic the turning motion is merely reversed with a switch.

Offset links of the present application have reaction fixture connections to accommodate any reaction configuration to meet any industrial requirement. Note that the transmission housing does not react but it passes the reaction force applied by the tool to it on to the link, which does react. The reaction force is absorbed by both the housing, which might tilt it relative to the link, and the link to maintain alignment on the nut to ensure extended product life.

Furthermore such offset drive link assemblies maximize operator safety and portability and minimize tool twisting forces, overall tool size, tool and fastener side loads, fastener bending forces, fastener thread galling and other fastener damage.

Generally referring to offset drive link assemblies of the present invention for transmission and multiplication of torque from a device (not shown) for tightening or loosening a threaded fastener (not shown) includes: drive force input assembly 100 having drive force input engagement 101 to receive first turning force 120 from the device acting in first direction 122; drive force output assembly 200 operatively engageable with drive force input engagement 101 having drive force output engagement 201 to transfer first turning force 120 to the fastener; and reaction force assembly 400 having reaction force input engagement 466 to receive second turning force 121 from the device in second direction 123 and reaction force output engagement 467 to transfer second turning force 121 to a stationary object.

Generally, drive force input engagement 101 is formed as drive force input gear 101 with an input polygonal adaptor 111. Drive force output engagement 201 is formed as a drive force output gear 201 with drive force output polygonal adaptor 211. Drive force output engagement 201 may include a plurality of interchangeable output gears, such as, for example, 291, 292 and 293. Reaction force assembly 400 includes a reaction force assembly housing 430 formed between reaction force input engagement 466 and reaction force output engagement 467. Reaction force input engagement 466 is formed as a raised portion 431 of reaction force assembly housing 430 with a reaction force input polygonal adaptor 432. Note that reaction force output engagement 467 may be formed as either: reaction force transfer fixtures 450, 450A, 450B or 450C (reaction arms); reaction force pin assembly 460A or 460B; a raised portion 485D of reaction force assembly housing 430 with a reaction force output polygonal adaptor 486; and/or any combination thereof.

More specifically, drive force input engagement 101 is formed adjacent first and second reaction housing portions 401 and 405; drive force output engagement 201 is formed adjacent third and fourth reaction housing portions 410 and 415; and reaction force input engagement 466 is formed adjacent first reaction housing portion 401. Note that reaction force output engagement 467 may be formed as either: reaction force transfer fixture 450 formed adjacent first, second, third and fourth reaction housing portions 401, 405, 410 and 415; reaction force pin assembly 460 formed adjacent either first and second reaction housing portions 401 and 405 and/or third and fourth reaction housing portions 410 and 415; and/or raised portion 485D formed adjacent fourth reaction housing portion 415.

The combination of a device for tightening or loosening a threaded fastener with offset drive link assemblies according to the present invention is herein disclosed.

Furthermore, a system for fastening objects is herein disclosed and includes: a threaded fastener; a device for tightening or loosening the threaded fastener; and offset drive link assemblies according to the present invention.

Advantageously the offset drive link assemblies of the present invention: allow access to previously unreachable fasteners due to, for example protruding threads, limited clearances and obstructions; make practical previously unusable devices driven either electrically, hydraulically, manually and/or pneumatically; makes feasible previously unusable advanced materials, such as, for example aircraft-grade aluminum; create modular components, such as, for example hex-reducing and -increasing drive bushings, male to female drive adaptors, to meet bolting application characteristics; yield accurate and customizable torque multiplication; tames drive force and reaction force application; overcome corrosion, thread and facial deformation; avoid bolt thread galling; nullify side load; ensure balanced bolt load for symmetrical joint compression; simplify link and tool use; minimize risk of operator error; and maximize bolting safety.

It will be understood that each of the elements described above, or two or more together, may also find a useful application in other types of constructions differing from the types described above. The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof. Note that there may be slight differences in descriptions of numbered components in the specification.

While the invention has been illustrated and described as embodied in a fluid operated tool, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

When used in this specification and claims, the terms “comprising”, “including”, “having” and variations thereof mean that the specified features, steps or integers are included. The terms are not to be interpreted to exclude the presence of other features, steps or components.

1. An apparatus for transmission and multiplication of torque from a device for tightening or loosening a threaded fastener including:
a drive force input assembly having a drive force input engagement to receive a first turning force from the device acting in a first direction;
a drive force output assembly, operatively engageable with the drive force input engagement, having a drive force output engagement to transfer the first turning force to the fastener;
a reaction force assembly having a reaction force input engagement to receive a second turning force from the device in a second direction and a reaction force output engagement including:
a recess to transfer the second turning force to a stationary object formed as a washer under the threaded fastener nonrotatably engageable with the recess; and
a removably and rotatably engagable reaction force transfer fixture formed as a reaction arm.

2. (canceled)

3. (canceled)

4. (canceled)

5. The apparatus according to claim 1 wherein the drive force input engagement is formed as a drive force input gear with a drive force input polygonal adaptor and wherein the drive force output engagement is formed as a drive force output gear with a drive force output polygonal adaptor.

6. The apparatus according to claim 5 wherein the drive force input polygonal adaptor is formed as a square drive, and wherein the drive force output polygonal adaptor is formed as either a hex drive or a 12 point drive.

7. (canceled)

8. The apparatus according to claim 7 wherein the reaction force input engagement is formed as a raised portion of the reaction force assembly housing with a reaction force input polygonal adaptor, and wherein the reaction force output engagement is formed as either a reaction force transfer fixture, a reaction force pin assembly and/or a raised portion of the reaction force assembly housing with a reaction force output polygonal adaptor.

9. (canceled)

10. The apparatus according to claim 8 wherein the reaction force input polygonal adaptor is formed as a spline connection; wherein the reaction force transfer fixture is formed as a reaction arm; wherein the reaction force pin assembly is formed as holes and pins; and/or wherein the reaction force output polygonal adaptor is formed as a recess for a reaction surface.

11. (canceled)

12. The apparatus according to claim 1 wherein the reaction force assembly includes:
a first, a second, a third and a fourth reaction housing portion;
wherein the reaction force input engagement is formed adjacent the first reaction housing portion; and
wherein the reaction force output engagement is formed adjacent to either the first, the second, the third and the fourth reaction housing portions, the first and the second reaction housing portions, the third and the fourth reaction housing portions, and/or the fourth reaction housing portion.

13. (canceled)

14. (canceled)

15. (canceled)

16. (canceled)

17. The apparatus according to claim 1 including a drive force idler assembly formed between the drive force input assembly and the drive force output assembly.

18. (canceled)

19. The apparatus according to claim 1 wherein the apparatus is connectable to and disconnectable from itself in components and the device as a unit, and wherein the apparatus is useable with devices of different types.

20. (canceled)

21. The apparatus according to claim 1 wherein either all of or portions of the drive force input assembly, the drive force output assembly and/or the reaction force assembly are either adaptable, detachable, exchangeable, flexible, interchangeable, manageable, removable, separable and/or transferable.

22. (canceled)

23. (canceled)

24. (canceled)

25. The apparatus according to claim 1 including:
wherein the drive force input engagement is formed as a drive force input gear with an input polygonal adaptor;
wherein the drive force output engagement is formed as a drive force output gear with a drive force output polygonal adaptor;
wherein the reaction force assembly includes a reaction force assembly housing formed between the reaction force input engagement and the reaction force output engagement;
wherein the reaction force input engagement is formed as a raised portion of the reaction force assembly housing with a reaction force input polygonal adaptor; and
wherein the reaction force output engagement is formed as either a reaction force transfer fixture, a reaction force pin assembly and/or a raised portion of the reaction force assembly housing with a reaction force output polygonal adaptor.

26. The apparatus according to claim 25 including:
wherein the drive force input polygonal adaptor is formed as a square drive;
wherein the drive force output polygonal adaptor is formed as either a hex drive or a 12 point drive;
wherein the reaction force input polygonal adaptor is formed as a spline connection;
wherein the reaction force transfer fixture is formed as a reaction arm;
wherein the reaction force pin assembly is formed as holes and pins; and/or
wherein the reaction force output polygonal adaptor is formed as a recess for a reaction surface.

27. The apparatus according to claim 12 including:
wherein the drive force input engagement is formed adjacent the first and the second reaction housing portions;
wherein the drive force output engagement is formed adjacent the third and the fourth reaction housing portions;
wherein the reaction force input engagement is formed as a raised portion of the first reaction housing portion with a reaction force input polygonal adaptor;
wherein the reaction force output engagement is formed as either:
a reaction force transfer fixture formed adjacent the first, the second, the third and the fourth reaction housing portions;
a reaction force pin assembly formed adjacent either the first and the second reaction housing portions or the third and the fourth reaction housing portions; and/or
a raised portion of the fourth reaction housing portion with a reaction force output polygonal adaptor.

28. The apparatus according to claim 27 including:
a drive force input polygonal adaptor of the drive force input engagement is formed as a square drive;
a drive force output polygonal adaptor of the drive force output engagement is formed as either a hex drive or a 12 point drive;
wherein the reaction force input polygonal adaptor is formed as a spline connection;
wherein the reaction force transfer fixture is formed as a reaction arm;
wherein the reaction force pin assembly is formed as holes and pins; and/or
wherein the reaction force output polygonal adaptor is formed as a recess for a reaction surface.

29. The apparatus according to claim 1 wherein the drive force output engagement includes a plurality of interchangeable output gears.

30. (canceled)

31. A system for fastening objects including:
a threaded fastener with a washer;
a device for tightening or loosening the threaded fastener; and
the apparatus according to claim 1.

32. The apparatus according to claim 1 wherein the reaction force input engagement is formed as a raised portion of one of the reaction force assembly housings with a reaction force input adaptor, and wherein the reaction force output engagement is formed as a raised portion of one of the reaction force assembly housings with a reaction force output adaptor.

33. The apparatus according to claim 32 wherein the reaction force input adaptor is formed as a spline connection, and wherein the reaction force output adaptor is formed as a recess for a reaction surface.

34. The apparatus according to claim 39 wherein the reaction force input engagement is formed adjacent the first reaction housing, and wherein the reaction force output engagement is formed adjacent the fourth reaction housing.

35. The apparatus according to claim 1 including:
wherein the drive force input engagement is formed as a drive force input gear with an input adaptor;
wherein the drive force output engagement is formed as a drive force output gear with a drive force output adaptor;
wherein the reaction force assembly includes a reaction force assembly housing formed between the reaction force input engagement and the reaction force output engagement;
wherein the reaction force input engagement is formed as a raised portion of the reaction force assembly housing with a reaction force input adaptor; and
wherein the reaction force output engagement is formed as a raised portion of the reaction force assembly housing with a reaction force output adaptor.

36. The apparatus according to claim 35 including:
wherein the drive force input adaptor is formed as a square drive;
wherein the drive force output adaptor is formed as either a hex drive or a 12 point drive; and
wherein the reaction force input adaptor is formed as a spline connection.

37. The apparatus according to claim 34 including:
wherein the drive force input engagement is formed adjacent the first and the second reaction housings;
wherein the drive force output engagement is formed adjacent the third and the fourth reaction housings;
wherein the reaction force input engagement is formed as a raised portion of the first reaction housing with a reaction force input adaptor; and
wherein the reaction force output engagement is formed as a raised portion of the fourth reaction housing.

38. The apparatus according to claim 37 including:
a drive force input adaptor of the drive force input engagement is formed as a square drive;
a drive force output adaptor of the drive force output engagement is formed as either a hex drive or a 12 point drive;
wherein the reaction force input adaptor is formed as a spline connection.

39. The apparatus according to claim 1 wherein the reaction force assembly includes a first, a second, a third and a fourth reaction housing and a first drive force input gear sleeve is formed between the first reaction force housing and the drive force input engagement, and a second drive force input gear sleeve is formed between the second reaction housing and the drive force input engagement.

40. The apparatus according to claim 1 wherein the recess is thin.

41. (canceled)
